(19) United States
(12) Patent Application Publication
(10) Pub. No.: US 2013/0054461 A1
(43) Pub. Date: Feb. 28, 2013

(54) METHODS, SYSTEMS, AND COMPUTER-READABLE MEDIA FOR ELECTRONIC FINANCIAL TRANSFERS

(71) Applicants: Somesh Gupta, Bangalore (IN); Srinivasan Sivasubramanian, Bangalore (IN); Ruchi Rakesh Pincha, Bangalore (IN)

(72) Inventors: Somesh Gupta, Bangalore (IN); Srinivasan Sivasubramanian, Bangalore (IN); Ruchi Rakesh Pincha, Bangalore (IN)

(73) Assignee: INFOSYS LIMITED, Bangalore (IN)

(21) Appl. No.: 13/342,526

(22) Filed: Jan. 3, 2012

(30) Foreign Application Priority Data
Aug. 23, 2011 (IN) 2856/CHE/2011

(51) Int. Cl. G06Q 20/40

(52) U.S. Cl. 705/44

(57) ABSTRACT

Computer-implemented systems, methods, and computer-readable media electronic for financial transfers include: receiving a request for a set of at least one Icheck tokens; generating the set of Icheck tokens, each Icheck token including a unique identifier, a set of payer data, and a set of signature data, wherein each Icheck token is configured to be transferable over plural media; transmitting the set of Icheck tokens to a payer device; receiving from a payee device an Icheck token from the set of Icheck tokens; authenticating the Icheck token by analyzing at least one of the unique identifier, the set of payer data, and the set of signature data; transmitting a non-payment notice if the authenticating step reveals the Icheck token is not authentic; and transmitting payment according to the set of signature data if the Icheck token is authentic.

### RELATED APPLICATION DATA

This application claims priority to Indian Patent Application No. 2856/CHE/2011, filed Aug. 23, 2011, which is hereby incorporated by reference in its entirety.

### BACKGROUND

Bank checks, credit union share drafts, and similar financial instruments (“checks”) have historically offered a convenient way for a payer (an entity making a payment) to make a payment to a payee (an entity receiving a payment). Apart from ease of use, checks offer benefits such as mobility in making payments, an offline mode of payment, strong legal standing, negotiability, traceability, and protection of payee account information. However, the use of checks has declined in recent years which has in turn led to an increase in the per-transaction cost of clearing checks.

Additionally, despite the many benefits of checks, whether processed via conventional paper check processing, check truncation, or check conversion, checks provide several inconveniences. A payer must carry a paper checkbook, or at least a single check, if they wish to write a check at their convenience. Additionally, every time a payer runs low or out of checks he or she must request another checkbook, which may include printing and shipping costs and delays. Both the payer and payee risk that a paper check may be lost (e.g., in the mail). A payee may also be inconvenienced due to delays in clearing checks. Delays may be due to various laws and regulations or due to the natural delay in transporting and clearing a huge volume of checks. Additionally, a payee generally must physically deposit a check at a bank or drop box.

These payer and payee inconveniences may be magnified for large organizations and businesses that handle large volumes of checks daily. While services, such as lockboxes and positive-pay, are offered to reduce the inconvenience to entities that need to handle large quantities of checks, these services are costly and only slightly mitigate some of the inconveniences. Similarly, remote deposit capture (“RDC”) may reduce the physical transfer of paper to a certain extent but may not be completely effective.

Paper checks are also inconvenient for banks, credit unions, and other financial institutions (“banks”). Banks may absorb costs related to checkbook printing, mailing and disbursing checkbooks, and the like if the costs cannot be passed to the payer. Additionally, much sophisticated and expensive equipment must be purchased, maintained, and run for check imaging, conversion, quality control, and other processing.

Improved systems and methods for financial transfers are desired.

### BRIEF DESCRIPTION OF THE DRAWINGS

FIG. 1 shows an exemplary system useful for creating, negotiating, presenting, and settling electronic financial transfer (“Icheck”) tokens.

FIGS. 2A-D show exemplary architectures for storing and transmitting Icheck tokens.

FIG. 3 shows a conceptual diagram of an exemplary Icheck token.

FIG. 4 shows an exemplary system similar to the system of FIG. 1 including an additional negotiation to a second payee.

FIG. 5 shows a conceptual diagram of an exemplary Icheck token including endorsement data.

FIG. 6 shows an exemplary process flow of steps performed by a payer bank to process Icheck tokens.

FIG. 7 shows an exemplary computing device useful for performing processes disclosed herein.

While systems and methods are described herein by way of example and embodiments, those skilled in the art recognize that systems and methods for electronic financial transfers are not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include”, “including”, and “includes” mean including, but not limited to.

### DETAILED DESCRIPTION

Disclosed embodiments provide computer-implemented methods, systems, and computer-readable media for electronic financial transfers (“Ichecks”). Ichecks may be preauthorized digital checks or tokens that may be used for making payments using any payment or communication channel. For example, payment channels may be over the internet, near field communication (“NFC”), Bluetooth, local area network (“LAN”), wide area network (“WAN”), mobile phone network, or any other communication network or combination of communication networks. Additionally, payment channels may be over more traditional channels, such as via a paper instrument, an oral transfer, an email, a short message service (“SMS”) message, and the like. A payer bank may issue a set of pre-authorized Icheck tokens to a payer device over any electronic communication channel. The payer using their payer device may then fill in payment information, digitally sign, and transfer the Icheck token to a payee's device. The payee may then deposit the Icheck token into a bank to convert the Icheck token to an electronic debit order on the payer's account at the payer bank Thus, Icheck tokens may provide a convenient system for financial transfers while reducing the costs associated with conventional check processing.

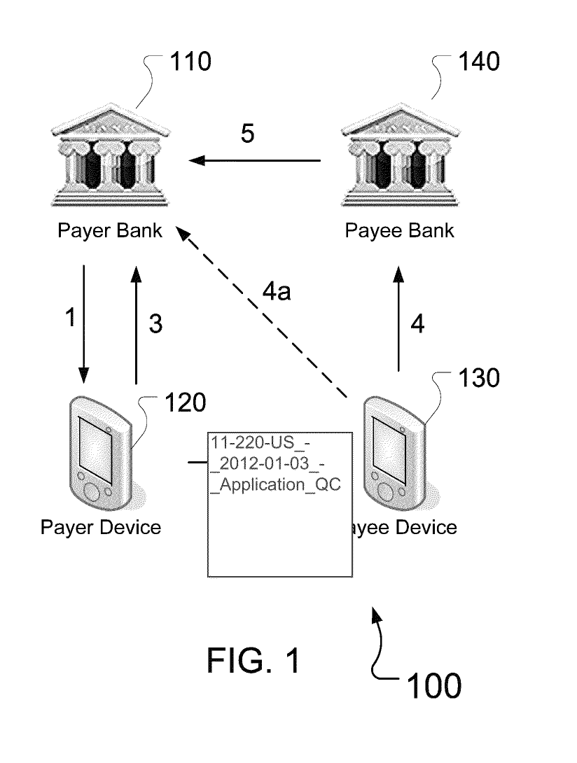

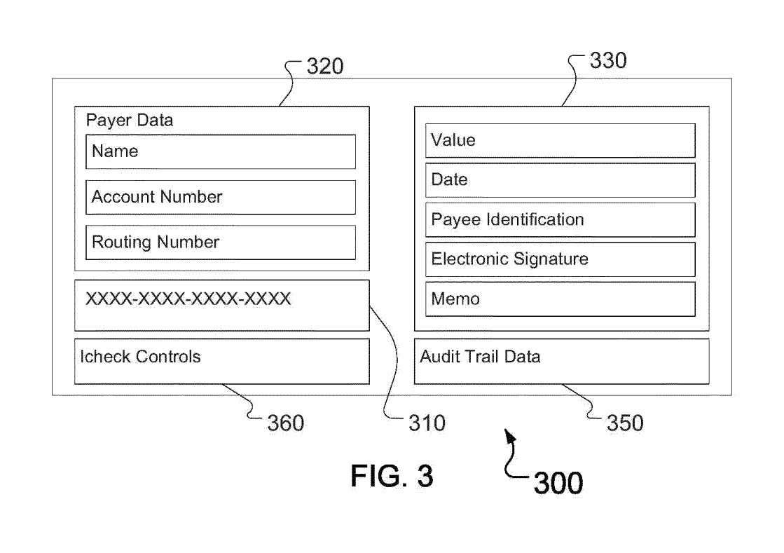

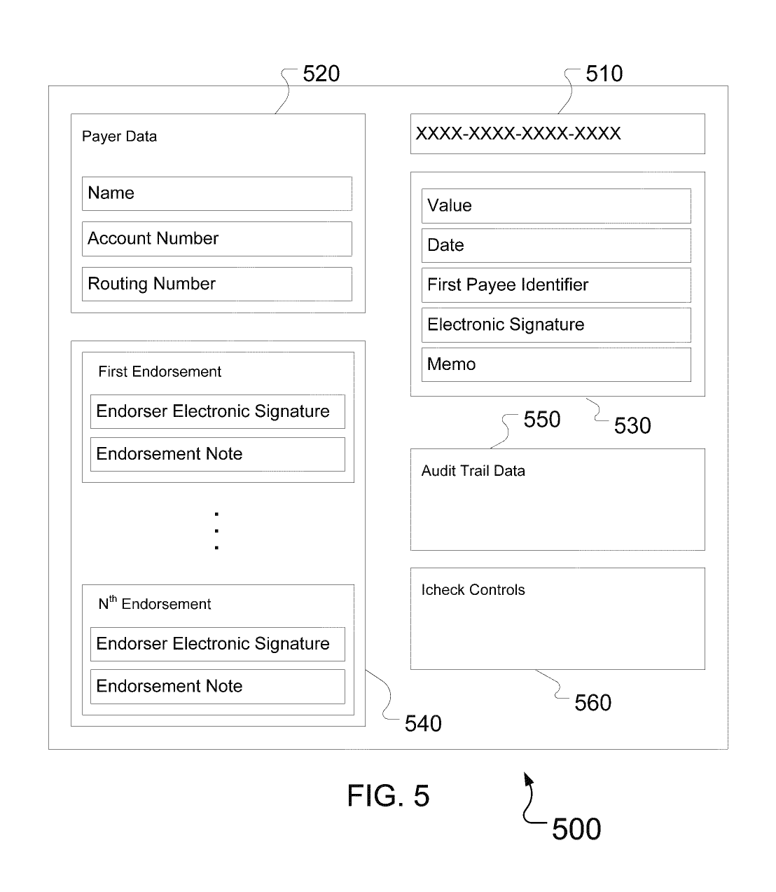

FIG. 1 shows an exemplary system 100 useful for creating, negotiating, presenting, and settling Icheck tokens. A payer bank 110 may have an account for a payer. The term “payer” is used herein to describe an entity transferring finances generally even before or after the payer actually transfers the finances (e.g., an account holder who can transfer via an Icheck token is referred to as a payer even if they have not actually been involved in a single financial transfer). Upon receiving a request from the payer (e.g., a distinct request or opening an account), the payer bank 110 may generate a set of one or more Icheck tokens for the payer. The Icheck tokens may be issued per channel and/or per device. Each Icheck token may include a unique identifier, a set of payer data, a set of Icheck signature data, and a set of audit trail data. The generation step may include generating the unique identifier, the payer data, and electronic traceability data in the audit trail data (e.g., initial channel information, device information, etc.) for each Icheck token. The unique identifier and payer data may be encrypted or otherwise encoded. In embodiments, however, a routing number or other identifier of the payer bank may be encoded in a fashion to facilitate presentment from a payee bank to the payer bank during the settlement process. Various data that may be included on each Icheck token are described in detail with reference to FIGS. 3 and 5 below.

At step 1 of FIG. 1, payer bank 110 may transmit the set of Icheck tokens to a payer device 120. Payer device 120 may be any computing device, e.g., a desktop computer, smartphone, tablet, special purpose Icheck device, or other computing device that may be accessed by the payer or an entity (e.g., person) authorized by the payer. For simplicity, this exemplary embodiment will discuss the payer device as if it were a smartphone, however any computing device may be used. And while various communication ports and media described herein may be suitable for a current smartphone, alternatives may be used. Transmitting the set of Icheck tokens from payer bank 110 to payer device 120 may include storing the Icheck tokens in an accessible channel (e.g., cloud storage, a network attached storage (“NAS”) device, web server, etc.) that may be accessed by payer device 120 and payee device 130.

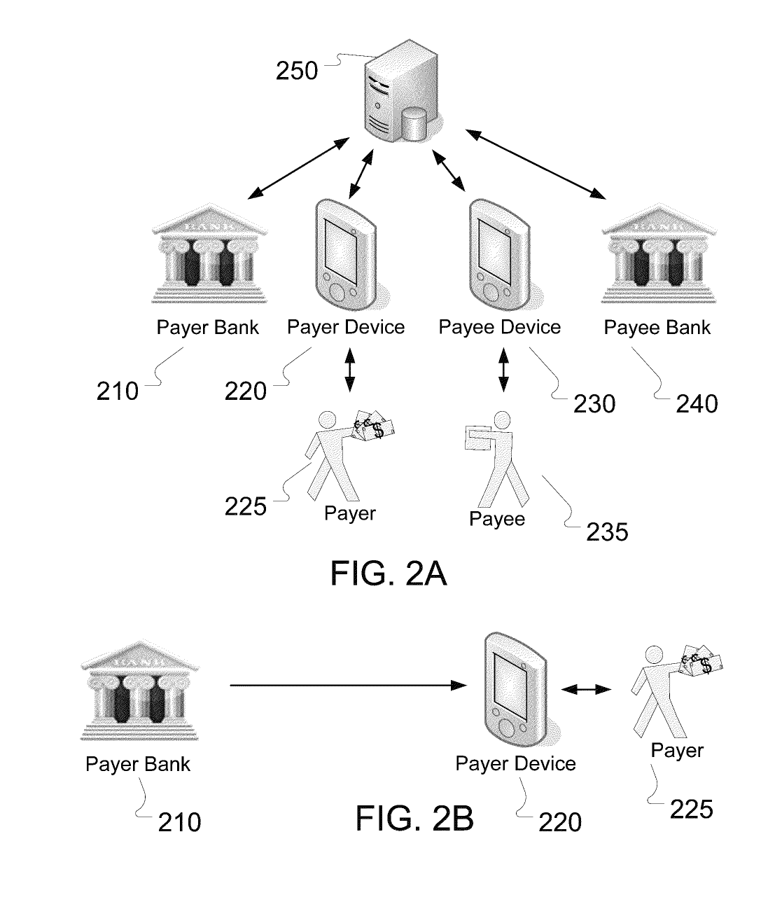

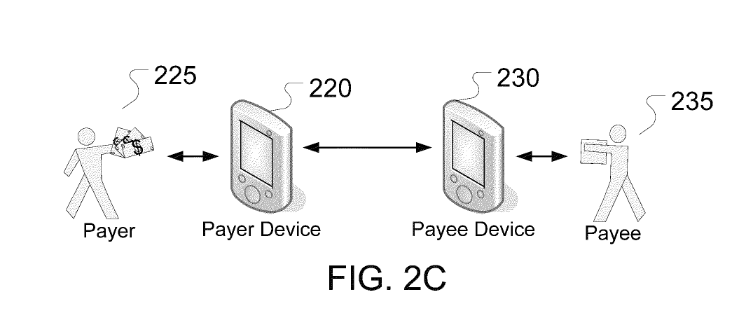

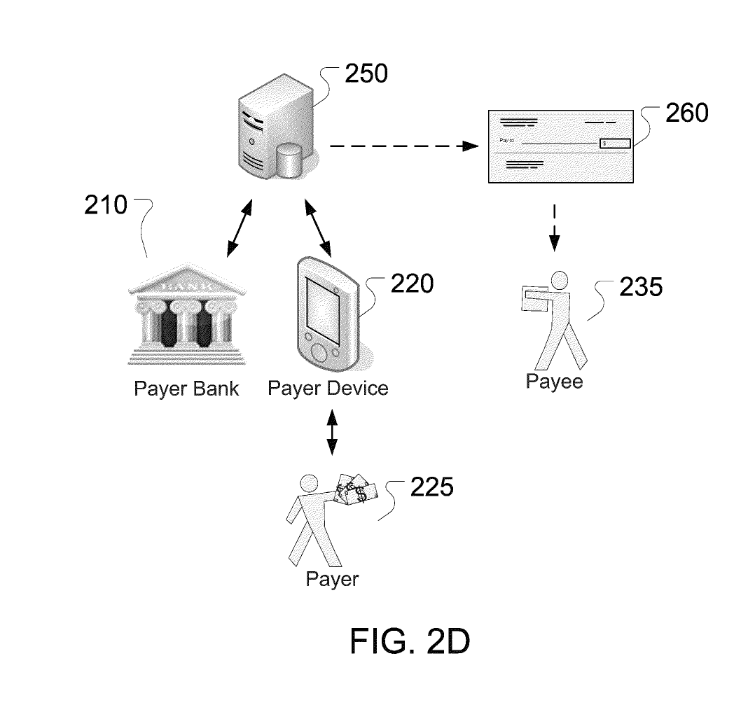

FIG. 2A shows an exemplary architecture for storing Icheck tokens in an accessible channel 250. A payer bank 210 may be in communication with accessible channel 250 via a communication medium (e.g., a network connection). Storing the set of Icheck tokens may include payer bank 210 transmitting Icheck tokens to accessible channel 250 or may simply include payer bank 210 instructing the accessible channel 250 to create Icheck tokens according to certain criteria. Once the Icheck tokens are stored on the accessible channel 250, a payer 225 may login to the accessible channel 250, for example with a mobile payer device 220 (e.g., via a login and password, a locally stored authentication certificate, an RSA key, and the like), to access the Icheck tokens. A notification (e.g., email, SMS message, interactive voice response (“IVR”) message, etc.) of the transmission may be sent from the payer bank 210 or accessible channel 250 to payer device 220 once the Icheck tokens are stored (i.e., the Icheck tokens are available for the payer to access on the accessible channel 250). Of course, while FIG. 2A illustrates payer bank 210 and accessible channel 250 as separate entities, in some embodiments payer bank 210 may also serve as accessible channel 250.

Referring to step 2 of FIG. 1 and the architecture of FIG. 2A, when a payer 225 wishes to transfer funds to a payee 235, the payer 225 may use payer device 120 to access an Icheck token. The payer 225 may access an Icheck token via a user interface (e.g., of an application (i.e., an app), a web browser, etc.) on the payer device 220. The payer 225 may then enter a set of Icheck signature data including a payee name (or account number or alternative payee identifier), an amount (optionally including a currency identifier), an electronic signature of the payer, and optionally other data (e.g., a memo noting the purpose of the payment). The payer device 220 may then electronically transfer the Icheck token to the payee device 230, for example after the payer 225 selects a user interface control. Transferring the Icheck token to the payee 235 may include sending (e.g., via the internet, email, etc.) a digital Icheck token to be stored locally on payee device 230, providing the payee 235 access to the accessible channel 230 (e.g., via a web interface, an application, etc.), or transferring the Icheck token via any other route. Payer 225 may also transmit a notice (e.g., email, SMS, etc.) to payee 235 to notify them of the Icheck token transfer. Step 2 of FIG. 1 may also include a confirmation from payee device 130 (e.g., to payer device 220) confirming receipt of an Icheck token. Such a confirmation may additionally include a value, such as a hash value or a checksum, to confirm that the received Icheck token includes the correct data.

At step 3 of FIG. 1, the payer device 120 may transmit a pre-notification to the payer bank 110. The pre-notification may include the signature data and unique identifier from the Icheck token transferred from the payer to the payee. The payer bank may use the pre-notification to mark the Icheck token as consumed so that the Icheck token cannot be reused. Additionally, the pre-notification may be useful for validating received Icheck tokens in the presentment process. Of course, one or all of the steps described in step 3 as being performed by payer bank 110 may alternatively or also be performed by accessible channel 250. In alternative embodiments, step 3 may be omitted.

At step 4 of FIG. 1, a payee may present (e.g., for deposit, cash, etc.) the Icheck token to payee bank 140 via a communication channel. For example, if the Icheck token is stored on accessible channel 250, a payee 235 may use payee device 230 to communicate (e.g., via email, SMS message, voice message, or other communication) to the payee bank 240 the details of the Icheck token. In some embodiments, the payee bank 240 may be an automated teller machine (“ATM”) and payee 235 may communicate the details of the Icheck token via the ATM (e.g., enter details into the ATM screen, communicate with the ATM with payee device 130 via NFC, and the like). Alternatively, if at step 2 an Icheck token was stored on payee device 230, payee device 230 may transfer the Icheck token to payee bank 240 via a communication medium.

At step 5, the payee bank 140 may initiate a one-off direct debit transaction to the payer's account taking the Icheck token as authorization. The debit may indicate the routing and account information for the payee's account as well as the unique identifier, signature data, and payer data from the Icheck token. The payer bank 110 may then verify the authenticity of the Icheck token and inter-bank settlement may take place. Verification of the Icheck token is discussed in greater detail below.

In alternative embodiments, the payee may present the Icheck token directly to the payer bank 110. For example, step 4a shows that a payee may present an Icheck token directly to the payer bank 110 to cash the check or to deposit the check in an account the payee has with the payer bank 110. After presentment, the payer bank 110 may verify the Icheck token. If the Icheck token is deemed valid, the payer bank may perform an on-us transaction (e.g., a book transfer on both accounts) to settle the transaction or may cash the Icheck token.

While the above example primarily discloses some channels and media over which Icheck tokens may be transferred, the steps of procuring Icheck tokens (i.e., step 1 of FIG. 1), passing Icheck tokens (i.e., step 2 of FIG. 1), pre-notifying (i.e., step 3 of FIG. 1), and presenting Icheck tokens (i.e., step 4 of FIG. 1) may be performed on any channel or medium. Additionally, the individual steps may be performed on different channels and media irrespective of other steps.

For example, FIG. 2B shows an exemplary architecture for transmitting the set of Icheck tokens from payer bank 210 to payer device 220 including transmitting the Icheck tokens from payer bank 210 to payer device 220 and storing the Icheck tokens in a memory (e.g., a non-transitory memory) of payer device 220. An electronic transfer may, for example, take place via email, the internet, WAN, LAN, NFC, mobile phone network, and the like. In such embodiments, a payer may then transmit an Icheck token directly from their payer device to a payee's computing device. FIG. 2C illustrates an exemplary architecture for a payer 225 to transmit an Icheck token from their payer device 220 to a payee device 230. The transmission may be via any medium, such as Bluetooth, NFC, and the like. At the same time or shortly after payee device 220 transmits an Icheck token to payee device 230, payer device 220 may transmit a pre-notification, for example to a payer bank. Once the payee 235 receives the Icheck token on their payee device 230, they may then transmit (i.e., present) the token to an ATM or their bank, for example over the internet, a mobile phone network, an NFC, and the like.

In still other embodiments, non-digital transmissions may be utilized in an Icheck system. For example, FIG. 2D illustrates an exemplary architecture for transmitting a paper Icheck 260 to a payee 235. As shown in FIG. 2D, a payer bank 210 may generate a set of Icheck tokens and a payer 225 may use a payee device 220 to write an Icheck token to a payee 235. An accessible channel 250 (or payer bank 210) may then print a paper check 260 in conventional fashion based on the information of the Icheck token and transmit a paper check to the payee. A print may also be taken at an ATM. The paper check may conform to conventional check standards (e.g., include information about the payer 225 on the MICR line, etc.), or may encrypt some or all information traditionally printed on a check with the exception of sufficient data for a payee bank to correctly route the check for processing.

In still other embodiments, Ichecks may be transmitted in the form of SMS messages, over email, or any other means of communication. By providing a unique combination of identifying data, such as the unique identifier, payer data, and signature data, independent of the transmission type, a payer bank may be able to validate the authenticity of an Icheck and, thus, honor the Icheck. After such transmission, a payer may pre-notify the payer bank via any medium or channel.

Referring now to FIG. 3, a conceptual diagram of an exemplary Icheck token 300 is shown. Icheck token 300 may be a data structure stored in a memory of a computing device (e.g., a non-transitory memory). Each Icheck token 300 may include a unique identifier 310, a set of payer data 320, and a set of Icheck signature data 330. The unique identifier 310 may be a number, an alphanumeric string, or any other type of identifier. The unique identifier 310 may be configured to generate a new unique identifier at fixed intervals (e.g., every 30 seconds) or may be static. Additionally, the unique identifier 310 may incorporate data relating to the Icheck signature data 330 (e.g., incorporate a hash of the signature data), thus assisting with a validation check of the signature data. A portion of or the entire unique identifier 310 may be encrypted. In some embodiments, a portion of the unique identifier may be a non-encrypted number similar to a conventional check number (e.g., consecutive Icheck tokens may include consecutive unique identifiers xxxx-xxxx-xxxx-x161 and xxxx-xxxx-xxxx-x162).

Each Icheck token 300 may also include a payer data set 320. The payer data set 320 may include, for example, the name of the payer, an account number of the payer's account, and a routing number for the payer bank In some embodiments, some or all of the set of payer data 320 may be encrypted or otherwise hidden from view of a payee, thus optionally providing the payer an increased degree of privacy in comparison to conventional checks. In other embodiments, the payer data set may be freely visible to a payee. The payer data set 320 may be populated by the payer bank when generating a set of Icheck tokens and may be configured to disable modification (e.g., may be read-only).

Each Icheck token 300 may also include an Icheck signature data set 330. The signature data set may contain various data found on conventional checks, such as a value of the check, a date of the check, a payee identifier, a signature, and a memo optionally indicating the purpose of the check.

The value of the check may indicate the amount of currency to be transferred from the payer's account to the payee. A system for writing Icheck tokens on a computing device may preclude a payer from entering a value greater than available funds in their payer account or provide the payer with an error or warning if the payer attempts to overdraw an account. In other embodiments, a payer may be limited to writing Icheck tokens for no more than the amount in their account less any outstanding issued Icheck tokens. In still other embodiments the system may allow the payer to enter any value in an Icheck token, thus allowing the payer to issue Icheck tokens while depending on float. In this case, a payer may bounce an Icheck if insufficient funds are in the account at the time of presentment. Other Ichecks may have a maximum possible value. In some embodiments, the currency of an Icheck token may be predetermined while in other embodiments a payer may select from one of a plurality of available currencies for an Icheck.

The date of an Icheck token may be the date the payer electronically signs the Icheck token. The date may be automatically filled by a system when the payer electronically signs. Alternatively, a payer may be able to select the date of an Icheck token, for example to delay payment of an Icheck token until a future date when the payer intends to have sufficient funds in their account to cover the value of the Icheck token. Icheck tokens may also expire after a certain time, for example an Icheck token may only remain payable for a number of days (e.g., ninety days) after the Icheck token is signed. Some Icheck tokens may additionally include an expiration date field to allow a payer to expressly define an expiration date (or similarly, an expiration time span from the signature date) for an Icheck token.

The payee identifier of an Icheck token may identify the payee in any fashion. For example, the payee identifier may be the name of the payee, a routing number and account number to invest the Icheck token into, and the like. An Icheck token may only require that the payee identifier sufficiently clearly identify who the payee is. Thus, private information (e.g., account numbers, etc.) of the payee may be kept private. In some instances, a payee may be indicated as “cash” or “the bearer” or another indicator that the instrument is payable to the bearer. However, in some embodiments Icheck tokens may disable being written to payee identifiers that identify the Icheck token as analogous to conventional bearer paper to increase security and traceability.

The electronic signature may be a secure payer authentication. For example, a payer may have a secure key or password they utilize to securely sign an Icheck token using a computing device. Current standard technologies, such as public key infrastructure (“PKI”), may be used. Additionally, any future developed technologies may be used. In some embodiments, a computing device may include a biometric reader (e.g., a thumbprint reader on a laptop, a camera on a smartphone may be used as an iris scanner or for facial recognition, etc.) to authenticate a payer's electronic signature. In some embodiments, a payer may “sign” an Icheck token using their finger or a stylus on a touch pad (e.g., by drawing their signature on the touch-screen of a smartphone).

Embodiments may also require more than one signature, for example for Ichecks written from joint accounts. In such instances, a first payer may digitally sign an Icheck token and transmit the Icheck token to a second payer to also digitally sign before the Icheck token may be payable to the payee. In other embodiments, a first and second payer may both access an accessible channel (e.g., hosted on a web server) to digitally sign an Icheck token. Of course, in some embodiments one of plural holders of a joint account may be able to digitally sign an Icheck token without the digital signature of any other account holders.

The memo line may allow a payer to leave a memorandum or note on an Icheck token to either indicate to themselves or to the payee, for example, the purpose of the payment. Of course, Icheck signature data set 330 may include different or additional information as well. Optionally, some or all of the data in Icheck signature data set 330 may be encrypted or hidden from view of a payee, although embodiments may generally provide non-encrypted Icheck signature data to allow a payee to view the data.

Each Icheck token 300 may also include audit trail data 350. Audit trail data may include any data indicating the path that an Icheck token has traveled. Audit trail data may be initially generated to show channel information, device information, and the like identifying where the Icheck token is initially stored. Every time any data on an Icheck token is changed or an Icheck token is transferred between computing devices, the Icheck token may store a timestamp, a log of the data addition or change, communication data (e.g., IP address from the transmitting and receiving computing device), and any identifying information of the sending and receiving computing devices (e.g., MAC addresses). A validity check performed by the payer bank may also include inspecting the audit trail data 350.

Each Icheck token 300 may further include Icheck controls 360. Icheck controls 360 may set forth limitations for the specific Icheck token 300. For example, channels the Icheck token may be transferred over, whether the Icheck token is negotiable, signature requirements, whether the Icheck token may be written to a bearer, and the like.

Once a payer bank receives an Icheck token, whether from a payee bank (e.g., step 5 of FIG. 1), directly from a payee device (e.g., step 4a of FIG. 1), or via any other route, the payer bank may determine the validity of the Icheck token. Checking validity may include one or more of checking authentication of an Icheck token and checking that the Icheck token matches any pre-notification data. Other embodiments may utilize a pre-notification validity check when a pre-notification is received but not require pre-notification (e.g., to facilitate offline transfers of Icheck tokens).

Authenticating an Icheck may include first determining if the payer data corresponds to a valid payer account. The payer bank (identified by the routing number) may determine that the payer name and payer account number correspond to an account held by the bank Authenticating an Icheck may also include determining whether the unique identifier corresponds to preauthorized Icheck token. Because each Icheck token may receive a unique identifier when it is first generated, the payer bank may check whether the authentication number corresponds to an Icheck token that was issued and has not yet been paid. For additional security, some embodiments may require receipt of a pre-notification (e.g., step 3 of FIG. 1) after a payer writes an Icheck token before the check having a certain unique identifier may be determined authentic by the payer bank

Authenticating an Icheck may also include authenticating the Icheck signature data set. For example, the electronic signature may contain encrypted data identifying that it was digitally signed by the payer rather than an unauthorized party. Additionally, the unique identifier may be encoded to include information from one or more fields from the Icheck signature data set. For example, a cryptographic hash function may incorporate Icheck signature data set data in the unique identifier. Thus, a computing device may determine an Icheck invalid (e.g., tampered with or forged) if the unique identifier fails to correctly correspond to the Icheck signature data set.

Embodiments may also validate an Icheck by comparing the Icheck signature data set with a pre-notification received from the payer device (e.g., step 4a in FIG. 1). Such a step may be a direct comparison to determine if any data has been tampered with.

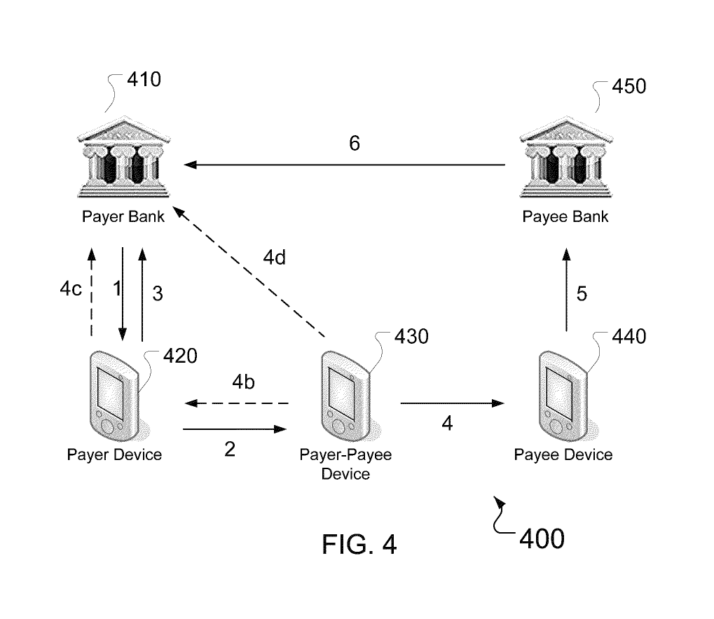

Icheck tokens may additionally be negotiable between parties. In other words, once a payee receives an Icheck token, they may be able to transfer their interest in the payment from the payer's account to a new payee. FIG. 4 shows an exemplary system 400 similar to system 100 above but including an additional negotiation to a second payee. As shown in FIG. 4, a payer bank 410 may generate a set of Icheck tokens and transmit them to payer device 420 in similar fashion to that discussed above with reference to FIG. 1. For simplicity, all transmissions in FIG. 4 will simply be referred to as “transmissions”, however, as discussed with reference to FIGS. 1 and 2A-2D, each transmission may be via any medium irrespective of other transmissions in the system. At step 2, a payer may use payer device 420 to draft an Icheck token and transmit the Icheck token to payer-payee device 430. Payer device 420 may additionally transmit a pre-notification to payer bank 410 indicating that the Icheck token was transmitted and relevant data from the Icheck token at step 3. At step 4, payer-payee device 430 may endorse the Icheck token to a second payee. In other words, a user (e.g., the first payee) of payer-payee device 430 may indicate that the endorsement is a special endorsement to a new payee, indicate the new payee's identity on the Icheck token, and transmit the Icheck token to payee device 440. Payee device 440 may then transmit the Icheck token to a payee bank 450 in step 5 in similar fashion to step 4 in FIG. 1 (or may directly transmit the Icheck to payer bank 410 in similar fashion to step 4a).

To ensure authorization of all negotiations, a computing device negotiating an Icheck token to a downstream payee may transmit a notification of the negotiation (e.g., including a payee identifier and a digital signature of the endorsing party (i.e., the payer-payee)) in step 4b. The payer device 420, in turn, may transmit a pre-notification of the negotiation to payer bank 410 in step 4c. Alternatively, a computing device negotiating an Icheck token to a downstream payee may transmit a notification of the negotiation directly to payer bank 410 in step 4d.

As discussed in relation to the negotiation in FIG. 4, some Icheck tokens may include data identifying one or more downstream endorsees and payees. FIG. 5 shows a conceptual diagram of an exemplary Icheck token including data corresponding to downstream endorsees and payees. Icheck token 500 includes a unique identifier 510, payer data set 520, and Icheck signature data set 530 in similar fashion to Icheck token 300 discussed above with reference to FIG. 3. Icheck token 500 may also include an endorsement data set 540 which may include endorsements from one or more holder of the Icheck token (i.e., a payee who had physical control of the Icheck token) and one or more endorsement notes. An Icheck token may be configured to receive one or more restrictive endorsements, for example a payee may endorse an Icheck token by electronically signing the Icheck token and providing the endorsement note “for deposit only”. Other times, such as in the negotiation example of FIG. 4, a special endorsement may transfer the payment to a new payee. For example, the endorsement note may read “pay to the order of <NEW PAYEE>” and may be accompanied by the electronic signature of the holder. Other known endorsements (e.g., blank, qualified, etc.) and combinations of endorsements may entered in Icheck tokens as well.

Icheck token 500 may also include audit trail data 550. Audit trail data may include any data indicating the path that an Icheck token has traveled. For example, every time any data on an Icheck token is changed or an Icheck token is transferred between computing devices, the Icheck token may store a timestamp, a log of the data addition or change, communication data (e.g., IP address from the transmitting and receiving computing device), and any identifying information of the sending and receiving computing devices (e.g., MAC addresses). A validity check performed by the payer bank may also include inspecting the audit trail data 550. In embodiments where an Icheck token is transmitted as a paper Icheck (or in any other non-digital format that does not include audit trail data 550), the audit trail data may be converted into an encrypted code and printed on the paper Icheck.

Icheck token 500 may also include Icheck controls 560. Icheck controls may set forth limitations for the specific Icheck token 500. For example, for a payer with limited funds in their account, a payer bank may generate an Icheck token having an Icheck control limiting the maximum funds that can be transferred with the Icheck token. Other embodiments may require a pre-notification to be transmitted from a payer device to the payer bank before the payer bank will release funds to settle a received Icheck token. Other embodiments may limit ways that an Icheck token may be negotiated (e.g., may require an Icheck to be negotiated only between computing devices that can communicate the negotiation with the payer bank, may prevent negotiation all together, etc.). Embodiments may also limit whether an Icheck token may be endorsed to bearer, whether an Icheck token from a joint account requires signatures from a determined number of account holders, electronic signature requirements, encryption requirements, time limitations (e.g., date the Icheck token must be used by, how long an Icheck token may remain payable after signature, etc.) and the like. Some or all data stored in Icheck controls 560 may be encrypted or otherwise encoded. Additionally, some or all of the data stored in Icheck controls 560 may be viewable by a holder of the Icheck token to allow them to know the limitations of the Icheck token (e.g., whether it can be endorsed to another payee, to a bearer, etc.).

Of course, embodiments are not limited by the exemplary information shown on Icheck token 500. Still other embodiments may provide for certified checks (e.g., the payer bank may certify the payment amount is available). Additionally, embodiments may allow a payer to issue a stop payment order while the Icheck is floating (i.e., between when the Icheck token is issued to the payee and when the Icheck token is presented to the payer bank for settlement). Additionally, some embodiments may include less data on an Icheck token.

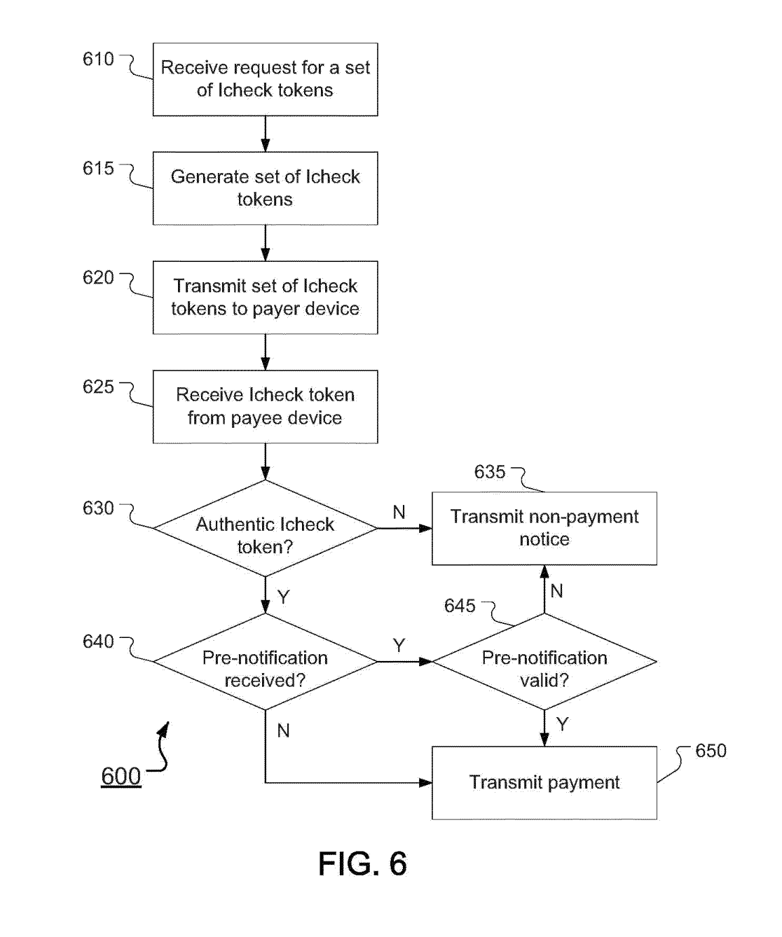

FIG. 6 shows an exemplary process flow 600 of steps performed by a payer bank to process Icheck tokens. At step 610, a payer bank computing device may receive a request for a set of Icheck tokens. The request may simply be an account being opened. Alternatively, a payer may make a request from a payer device (e.g., smartphone) for a set of Icheck tokens. In some embodiments, an application executed on the payer device may be configured to automatically request an additional set of Icheck tokens (e.g., ten additional tokens) once the number of available Icheck tokens falls below a threshold value (e.g., once the payer has less than three remaining Icheck tokens).

At step 615, a payer bank computing device may generate a set of Icheck tokens. The step of generating Icheck tokens may include generating a unique identifier for each Icheck token and populating a payer data set for each Icheck token. The step of generating may additionally include logging information regarding each Icheck token in a secure data set for later validation of the Icheck tokens upon presentment by a payee. At step 620, a payer bank computing device may transmit the set of Icheck tokens to a payer computing device. Of course, as described above, Icheck tokens may be transmitted across any medium, including both digital media (e.g., wireless communication media) and non-digital media (e.g., paper Ichecks).

At step 625, a payer bank computing device may receive an Icheck token from a payee device. The payee device may be a device controlled by the payee (e.g., a smartphone owned by the payee), a computing device controlled by a payee bank, an ATM, or any other device that may present an Icheck token to the payer bank and request payment.

At step 630, a payer bank computing device may authenticate the received Icheck token. The authentication may include determining whether the unique identifier was generated by the payer bank The authentication may also include determining whether the Icheck token includes a valid signature of the payer. Authentication may further include determining whether encoded information on the Icheck token corresponds to the signature data. If the Icheck token is determined to not be authentic, at step 635 a payer bank computing device may transmit a non-payment notice to the entity that presented the Icheck token. The payer bank may also notify the payer so that they may be aware of the possible forgery, alteration, or other wrongdoing.

If the Icheck token is determined to be authentic, at step 640 a payee bank computing device may determine whether a pre-notification was received from the payer (or their payer device). If a pre-notification was not received, at step 650 a payer bank computing device may transmit payment of the value of (i.e., settle) the Icheck token. Alternatively, if a pre-notification was received, a payer bank computing device may determine whether the pre-notification is valid at step 645. If the pre-notification is found to not match the Icheck token, at step 635 a payer bank computing device may transmit a non-payment notice to the payee. Alternatively, if the pre-notification is found to match the Icheck token, at step 650 a payer bank computing device may transmit payment.

While the above describes process flow 600 from the perspective of the payer bank, as disclosed earlier, the process flow may be performed by any accessible channel. Additionally, the accessible channel may be one or more entities working in concert. Also, while process flow 600 is described at times as interacting with a payee device, the payee device should be understood to be any device that presents an Icheck to the payer bank (or accessible channel). For example, a payee device may be a device controlled by the payee (e.g., 130 of FIG. 1), a computing device controlled by a payee bank (e.g., 140 of FIG. 1), an ATM, or any other computing device. Of course, process flow 600 may also include additional steps corresponding to other features described in this disclosure. For example, additional validity checks may correspond to downstream negotiation (e.g., via endorsement over) from a first payee to a second payee, additional pre-notifications from downstream payees, limitations on Icheck tokens due to Icheck controls, and the like.

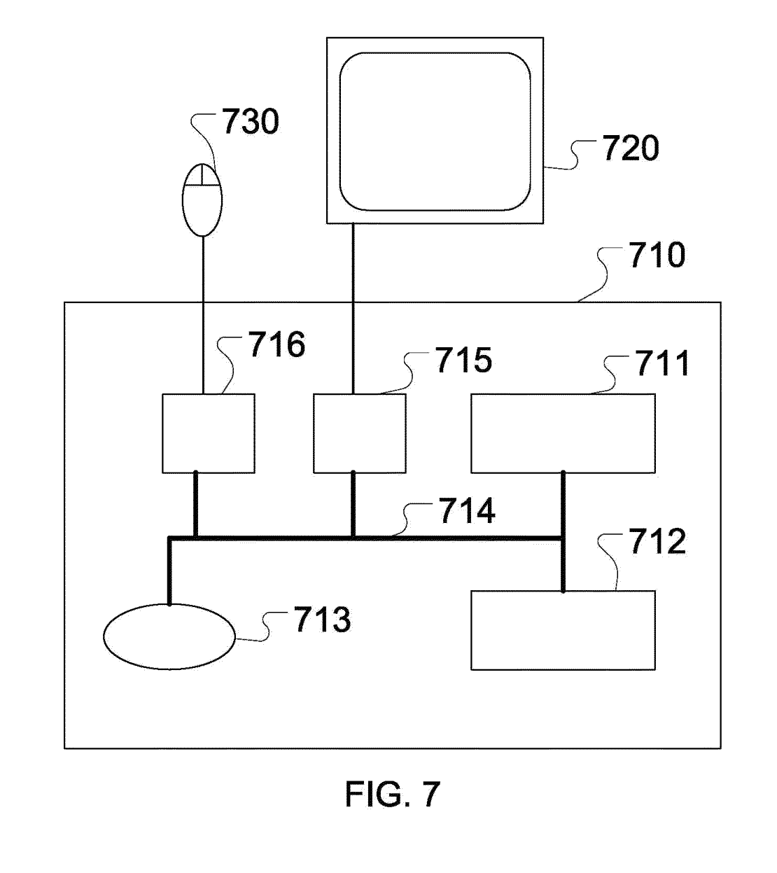

These embodiments may be implemented with software, for example modules executed on computing devices such as computing device 710 of FIG. 7. Of course, modules described herein illustrate various functionalities and do not limit the structure of any embodiments. Rather the functionality of various modules may be divided differently and performed by more or fewer modules according to various design considerations.

Computing device 710 has one or more processing device 711 designed to process instructions, for example computer readable instructions (i.e., code) stored on a storage device 713. By processing instructions, processing device 711 may perform the steps and functions disclosed herein. Storage device 713 may be any type of storage device (e.g., an optical storage device, a magnetic storage device, a solid state storage device, etc.), for example a non-transitory storage device. Alternatively, instructions may be stored in one or more remote storage devices, for example storage devices accessed over a network or the internet. Computing device 710 additionally may have memory 712, an input controller 716, and an output controller 715. A bus 714 may operatively couple components of computing device 710, including processor 711, memory 712, storage device 713, input controller 716, output controller 715, and any other devices (e.g., network controllers, sound controllers, etc.). Output controller 715 may be operatively coupled (e.g., via a wired or wireless connection) to a display device 720 (e.g., a monitor, television, mobile device screen, touch-display, etc.) in such a fashion that output controller 715 can transform the display on display device 720 (e.g., in response to modules executed). Input controller 716 may be operatively coupled (e.g., via a wired or wireless connection) to input device 730 (e.g., mouse, keyboard, touch-pad, scroll-ball, touch-display, etc.) in such a fashion that input can be received from a user.

Of course, FIG. 7 illustrates computing device 710, display device 720, and input device 730 as separate devices for ease of identification only. Computing device 710, display device 720, and input device 730 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing device 710 may be one or more servers, for example a farm of networked servers, a clustered server environment, or a cloud network of computing devices.

Embodiments disclosed herein may provide additional privacy over conventional payment systems, such as checking systems. In similar fashion to checking systems, a payer does not need to know much identifying information about a payee to draft an Icheck to the payee. Ichecks may also allow a payer to conceal much personal information, for example account numbers and the like.

Embodiments may additionally allow for faster processing than conventional checking systems, thereby reducing check float. Also, embodiments may be less expensive for participating financial instructions to implement by requiring less or no processing of physical (e.g., paper) checks.

Embodiments have been disclosed herein. However, various modifications can be made without departing from the scope of the embodiments as defined by the appended claims and legal equivalents.

What is claimed is:

1. A computer-implemented method executed by one or more computing devices for electronic financial transfers comprising:
receiving, by at least one of the computing devices, a request for a set of at least one Icheck tokens;
generating, by at least one of the computing devices, the set of Icheck tokens, each Icheck token including a unique identifier, a set of payer data, and a set of signature data, wherein each Icheck token is configured to be transferable over plural media;
transmitting, by at least one of the computing devices, the set of Icheck tokens to a payer device;
receiving, by at least one of the computing devices, from a payee device an Icheck token from the set of Icheck tokens;
authenticating, by at least one of the computing devices, the Icheck token by analyzing at least one of the unique identifier, the set of payer data, and the set of signature data;
transmitting, by at least one of the computing devices, a non-payment notice if the authenticating step reveals the Icheck token is not authentic; and
transmitting, by at least one of the computing devices, payment according to the set of signature data if the Icheck token is authentic.

2. The method of claim 1, further comprising:
receiving, from the payer device, a pre-notification including the set of payer data, the unique identifier, and the set of signature data; and
comparing the Icheck token with the pre-notification received from the payer device.

3. The method of claim 1, further comprising:
receiving, from the payer device, a pre-notification including the set of payer data, the unique identifier, and the set of signature data;
comparing the Icheck token with the pre-notification received from the payer device;
identifying a set of endorsement data;
determining the validity of the endorser electronic signature; and
determining the Icheck token endorsement.

4. The method of claim 1, wherein the Icheck token includes an endorsement data set configured to capture one or more endorser electronic signature and corresponding endorsement note, and
the method of claim 1 further comprising:
receiving, from the payer device, a first pre-notification including the set of payer data, the unique identifier, and the set of signature data;
receiving, from one of the payer device and a payee device, a second pre-notification including the at least one endorser electronic signature and corresponding endorsement note;
comparing the Icheck token with the first pre-notification and second pre-notification.

5. The method of claim 1, wherein the Icheck token includes an audit trail and wherein the step of authenticating includes analyzing the audit trail.

6. The method of claim 1, wherein the unique identifier is configured to incorporate information about the set of signature data when a payer electronically signs the Icheck token with the payer device, and wherein the step of authenticating the Icheck token includes comparing the Icheck signature data with the unique identifier.

7. A system for electronic financial transfers comprising:
a memory; and
a processor operatively coupled to the memory, the processor configured to perform the steps of:
receiving, by at least one of the computing devices, a request for a set of at least one Icheck tokens;
generating, by at least one of the computing devices, the set of Icheck tokens, each Icheck token including a unique identifier, a set of payer data, and a set of signature data, wherein each Icheck token is configured to be transferable over plural media;
transmitting, by at least one of the computing devices, the set of Icheck tokens to a payer device;
receiving, by at least one of the computing devices, from a payee device an Icheck token from the set of Icheck tokens;
authenticating, by at least one of the computing devices, the Icheck token by analyzing at least one of the unique identifier, the set of payer data, and the set of signature data;
transmitting, by at least one of the computing devices, a non-payment notice if the authenticating step reveals the Icheck token is not authentic; and
transmitting, by at least one of the computing devices, payment according to the set of signature data if the Icheck token is authentic.

8. The system of claim 7, the processor further configured to perform the steps of:
receiving, from the payer device, a pre-notification including the set of payer data, the unique identifier, and the set of signature data; and
comparing the Icheck token with the pre-notification received from the payer device.

9. The system of claim 7, the processor further configured to perform the steps of:
receiving, from the payer device, a pre-notification including the set of payer data, the unique identifier, and the set of signature data;
comparing the Icheck token with the pre-notification received from the payer device;
identifying a set of endorsement data;
determining the validity of the endorser electronic signature; and
determining the Icheck token endorsement.

10. The system of claim 7, wherein the Icheck token includes an endorsement data set configured to capture one or more endorser electronic signature and corresponding endorsement note, and
the processor further configured to perform the steps of:
receiving, from the payer device, a first pre-notification including the set of payer data, the unique identifier, and the set of signature data;
receiving, from one of the payer device and a payee device, a second pre-notification including the at least one endorser electronic signature and corresponding endorsement note;
comparing the Icheck token with the first pre-notification and second pre-notification.

11. The system of claim 7, wherein the Icheck token includes an audit trail and wherein the step of authenticating includes analyzing the audit trail.

12. The system of claim 7, wherein the unique identifier is configured to incorporate information about the set of signature data when a payer electronically signs the Icheck token with the payer device, and
wherein the step of authenticating the Icheck token includes comparing the Icheck signature data with the unique identifier.

13. Computer-readable code stored on a non-transitory computer-readable medium that, when executed by a computing device, performs a method for electronic financial transfers, the method comprising:
receiving, by at least one of the computing devices, a request for a set of at least one Icheck tokens;
generating, by at least one of the computing devices, the set of Icheck tokens, each Icheck token including a unique identifier, a set of payer data, and a set of signature data, wherein each Icheck token is configured to be transferable over plural media;
transmitting, by at least one of the computing devices, the set of Icheck tokens to a payer device;
receiving, by at least one of the computing devices, from a payee device an Icheck token from the set of Icheck tokens;
authenticating, by at least one of the computing devices, the Icheck token by analyzing at least one of the unique identifier, the set of payer data, and the set of signature data;
transmitting, by at least one of the computing devices, a non-payment notice if the authenticating step reveals the Icheck token is not authentic; and
transmitting, by at least one of the computing devices, payment according to the set of signature data if the Icheck token is authentic.

14. The computer-readable medium of claim 13, the method further comprising:
receiving, from the payer device, a pre-notification including the set of payer data, the unique identifier, and the set of signature data; and
comparing the Icheck token with the pre-notification received from the payer device.

15. The computer-readable medium of claim 13, the method further comprising:
receiving, from the payer device, a pre-notification including the set of payer data, the unique identifier, and the set of signature data;
comparing the Icheck token with the pre-notification received from the payer device;
identifying a set of endorsement data;
determining the validity of the endorser electronic signature; and
determining the Icheck token endorsement.

16. The computer-readable medium of claim 13, wherein the Icheck token includes an endorsement data set configured to capture one or more endorser electronic signature and corresponding endorsement note, and
the method further comprising:
receiving, from the payer device, a first pre-notification including the set of payer data, the unique identifier, and the set of signature data;
receiving, from one of the payer device and a payee device, a second pre-notification including the at least one endorser electronic signature and corresponding endorsement note;
comparing the Icheck token with the first pre-notification and second pre-notification.

17. The computer-readable medium of claim 13, wherein the Icheck token includes an audit trail and wherein the step of authenticating includes analyzing the audit trail.

18. The computer-readable medium of claim 13, wherein the unique identifier is configured to incorporate information about the set of signature data when a payer electronically signs the Icheck token with the payer device, and
wherein the step of authenticating the Icheck token includes comparing the Icheck signature data with the unique identifier.

19. The computer-readable medium of claim 13, wherein the step of generating the set of Icheck tokens includes generating the set of Icheck tokens for at least one of a specific channel and a specific device, and
wherein each Icheck token in the set of Icheck tokens includes an Icheck control indicating the at least one of the specific channel and the specific device.
